(19) United States
(12) Patent Application Publication
(10) Pub. No.: US 2023/0400070 A1
(43) Pub. Date: Dec. 14, 2023

(54) ELECTRIC DRUM BRAKE MODULE COMPRISING AN INTEGRATED OPERATING BRAKE AND AN INTEGRATED ELECTRIC PARKING BRAKE

(71) Applicant: CONTINENTAL TEVES AG & CO. OHG, Frankfurt am Main (DE)

(72) Inventors: Matthias Schulitz, Frankfurt am Main (DE); Jens Hoffmann, Darmstadt (DE); Thomas Winkler, Mainz (DE)

(73) Assignee: Continental Automotive Technologies GmbH, Hannover (DE)

(21) Appl. No.: 18/249,256

(22) PCT Filed: Oct. 1, 2021
(86) PCT No.: PCT/DE2021/200137

§ 371 Date: Apr. 16, 2023

(30) Foreign Application Priority Data
Oct. 16, 2020 (DE) 10 2020 213 106.6

(51) Int. Cl. F16D 51/24; F16D 51/52; F16D 65/22; F16D 66/00

(52) U.S. Cl. CPC F16D 51/24; F16D 51/52; F16D 65/22; F16D 66/00; F16D 2121/24

(57) ABSTRACT

A combined drum wheel brake module comprises a brake holder which can be fixed on a motor vehicle for conjoint rotation and has a counter bearing which is equipped with two brake shoes. The brake shoes are mounted opposite one another for conjoint rotation and can be displaced radially outward in the direction of a brake rotor designed as a brake drum, and wherein, for the purpose of actuating the brakes, there are at least one transmission means and two actuating devices, which are made up as a hydraulic or electric service brake actuator and as an electric parking brake actuator. Both the service brake actuator and the electric parking brake actuator are placed fixed next to one another in a semi-circle on the brake holder.

### TECHNICAL FIELD

The invention relates to a drum brake system.

### BACKGROUND

A known simplex drum brake involves a counter bearing for the brake shoes for all braking functions and a wheel brake cylinder is provided for performing a service braking function. An electric wheel brake actuator, which acts on a brake shoe via an actuating cable, is used to perform a parking brake function, and the drive train of the wheel brake actuator is designed to be self-locking without current.

An objective of such drum wheel brake systems relates to mobile systems, such as for example motor vehicles, while other types of application—for example for or in industrial transport devices, capital goods such as production plants and/or in real estate, such as for example as a component of lifting systems, may appear to be quite possible and useful with appropriate adaptation.

EP 0 665 926 B1 discloses, by way of example, a conventional and combined-arranged motor vehicle drum brake comprising a hydraulic wheel brake cylinder and comprising a mechanical parking brake spreading device.

WO 2015/101486 A2 describes a combined motor vehicle drum brake without a counter bearing, comprising a hydraulic service brake actuator (wheel brake cylinder) with placement fixed in a first semicircle of a brake holder and with a simplex configuration in that the hydraulic service brake actuator (wheel brake cylinder) acts directly on first ends of brake shoes as a spreading device, and also including an electric parking brake with an electric parking brake actuator allocated in an opposite semicircle of the brake holder with duo-servo configuration by arranging a rod between the brake shoes, and the electric parking brake actuator acting as a spreading device substantially directly on the second ends of the brake shoes.

One object is to provide an alternative, for a motor vehicle drum brake system. On the one hand, it is aimed to obtain further-developed future security for any braking energy sources, and furthermore the installation space made available in a motor vehicle should be used as efficiently as possible.

### SUMMARY

A combined drum brake module has the two actuating actuator systems (FBA/BBA, i.e. parking brake actuator/service brake actuator) fixed next to one another on a common brake holder, e.g. an anchor plate, as far as possible in direct proximity. In other words, the two actuator systems are not allocated diametrically at a distance from one another, as is customary in the prior art, but rather are arranged in a locally concentrated manner. This allows utilization of installation space and arrangement and laying of possibly different necessary connection interfaces I1, I2 arranged almost so as to allow them to be bundled, is used for simple linking up with an electronic control unit ECU. An electrical connection of brake actuators 1a, 2 such as by way of example hydraulic connections, actuator power connections, and sensor cable routing, to a control unit (H)ECU is therefore made possible. As a result, the brake module is accordingly suitable for rationalizing an assembly process in an automobile plant, or at least making it more reliable, because it is essentially conducive to a centralized interface design.

In one development a “dual mode” (motor vehicle) drum brake system module can be provided. By way of example, this allows a simplex drum brake in relation to service braking systems, such as for practical braking torque control behavior for the purpose of sensitive performance of braking torque control tasks, to be combined with a design-based system-inherent blocking behavior or the efficiency of the duo-servo drum brake type. Thus, this development results in a efficient and reliable parking brake function in connection with heavy motor vehicles, even if particularly miniaturized, lightweight parking brake actuator systems are used for this purpose.

For the first time a variation with a miniaturized parking brake actuator drive train—due to the use of the efficient duo-servo wedging principle with a force flow L closed in the form of a ring for the electric parking brake function in combination with a sensitively dosable and controllable electric service brake function by performing braking in a way analogous to the simplex design.

In a further embodiment, it is provided that the brake holder 3 has a circular disk-like geometry, and that the service brake actuator 2, BBA and the electric parking brake actuator 1a, EPBA are arranged placed within a common circle half A of the brake holder 3.

A interface design is achieved in that a semi-circle A comprising a service brake actuator 2, BBA and an electric parking brake actuator 1a, EPBA is arranged placed opposite a semi-circle B with a counter bearing 5.

### BRIEF DESCRIPTION OF THE DRAWINGS

The present disclosure will become more fully understood from the detailed description and the accompanying drawings, wherein:

FIG. 1 shows a perspective view of a drum brake module without a brake rotor,

FIG. 2 shows the drum brake module as in FIG. 1 in plan view with brake rotor 4 in simplex service braking mode, and

FIG. 3 shows the drum brake module as in FIG. 1 in plan view with brake rotor 4 however in duo-servo parking braking mode.

### DETAILED DESCRIPTION

A combined dual-mode drum brake module which arranges two function-dependently, service brake request or parking brake request, defining actuating actuator systems next to one another with direct or indirect insertion of the anchor plate 3 as a module. In a development, this takes place by the at least two actuator systems 1a, 2 being allocated opposite, directly or indirectly, alternately to both sides of the anchor plate 3 on the outside or inside but always offset in the same semicircle A. Here, the design with the actuator system arranged allows a concentrated interface design on an outside for the anchor plate 3 and for example a concentrated interface feed 11, 12 in relation to adjacent components, e.g. (H)ECU, of the necessary vehicle peripherals, e.g. concentrated hydraulic line feed, concentrated electric cable, i.e. power feed, concentrated wheel rotation sensor cable laying, etc.

In one embodiment, a dual mode drum brake module comprises the integral hydraulic service brake function and the integral electric parking brake function with a corresponding actuator system.

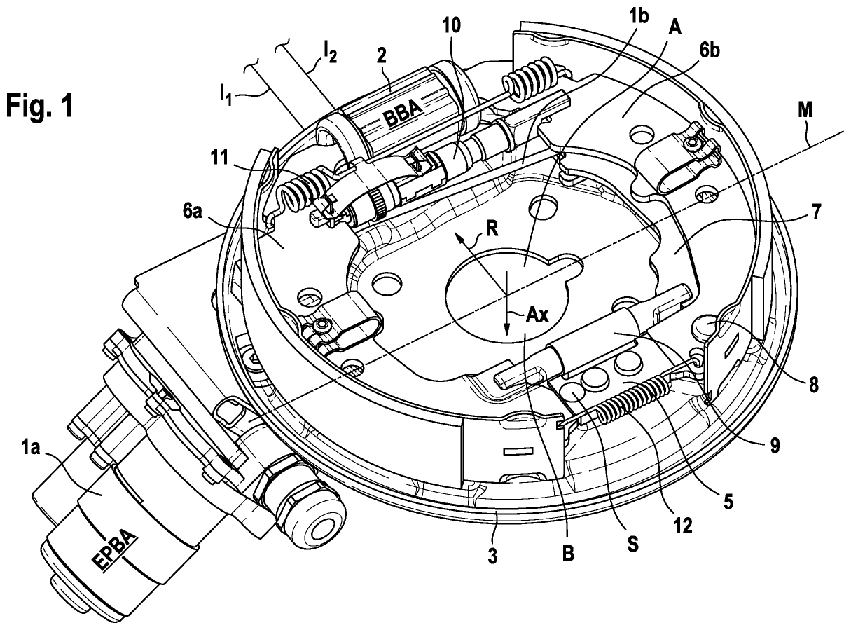

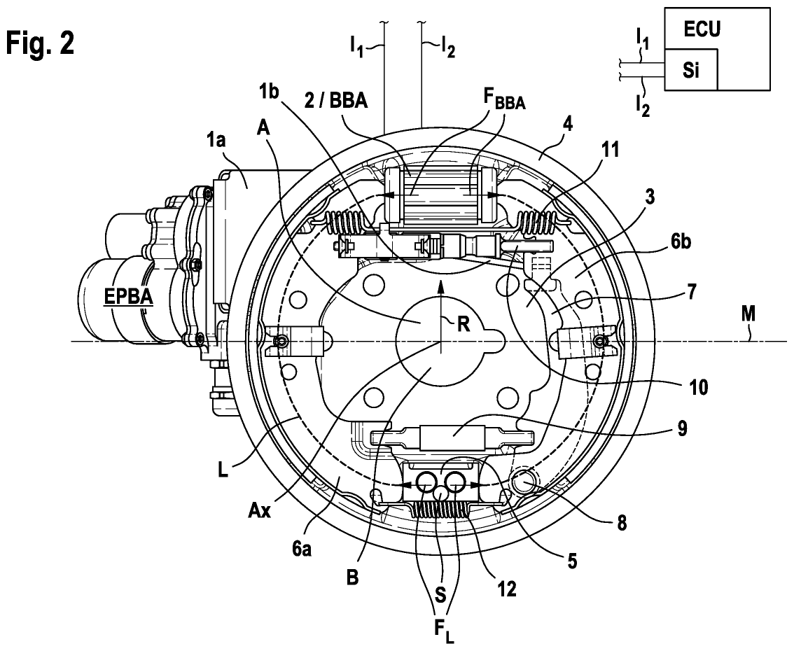

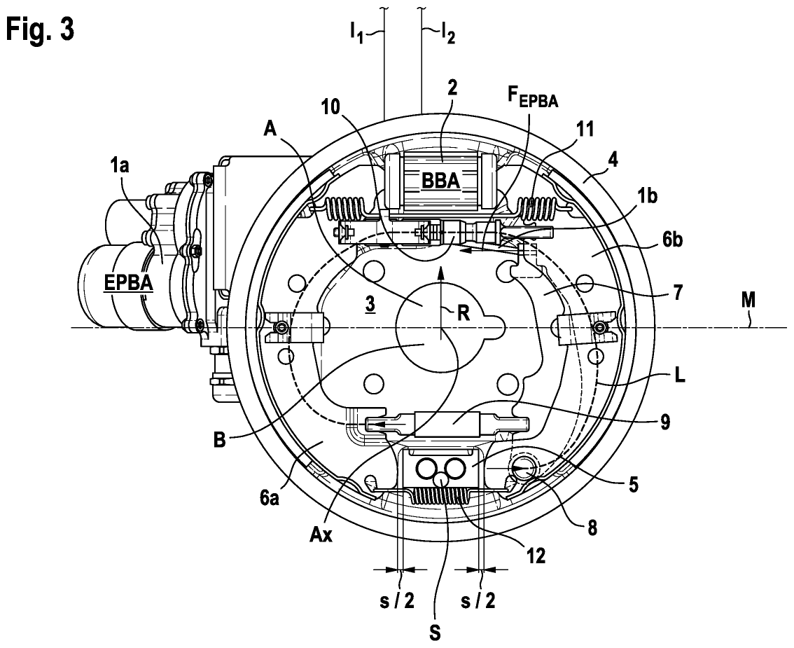

Although in the embodiment according to FIGS. 1-3 a hydraulic service brake actuator system 2, BBA is illustrated, a further embodiment of a dry brake system relates to a purely electric, i.e. an electromotive, service brake actuator. This embodies that the further-developed drum brake system module can to a certain extent be provided completely fluid-free as a fully electric or as an electromechanical brake system, e.g. EM-DB/electromechanical drum brake.

In one embodiment, the electric parking brake actuator system 1a is preferably made up as a rotationally and electromotively driven motor-gear actuating device (EPB-MGU) with for example multiple reduction gear stages and with a rot-trans converter gear stage. Currentless self-locking for the purpose of permanently blocking the parking brake action is integrated into any gear stage of an EPB motor-gear unit. In the embodiment of the rot-trans converter, the EPB-MGU includes a spindle-nut gear stage. The EPB-MGU is fixed on the rear side opposite, i.e. next to or beyond an area spanned by the brake drum on one side of the anchor plate and allows the brake actuation or adjustment of at least one brake element, e.g. brake shoe 6a, 6b by one or more transmission means involved (cable, lever and/or combination). A simultaneous application of actuating force to both brake shoes 6a, 6b respectively arranged directly on both brake shoes 6a, 6b is entirely conceivable in principle.

As the drawing also shows, the electromotive EPB-MGU 1a, EBPA is arranged to the greatest extent gradually at a common height or level as it were opposite, offset parallel, in relation to an allocated, for example electrically and/or hydraulically actuatable, spreading device/service brake actuator system 2, BBA oriented on the inside in the area of the anchor plate spanned by the brake drum circle segment A. The arrangement/placement of the EPB-MGU is consequently positioned in other words substantially directly that is to say opposite, adjacent, alongside, next to the service brake actuator system 2, BBA.

Cable and/or lever gear arrangements are suitable as transmission means 1b between the EPBA and the brake shoes 6a, 6b. An adjusting strut which can be telescopically expanded in its length in a friction-lining wear-dependent and currentless manner and can be automatically fixed is inserted between the brake shoes 6a, 6b for automatic, currentless adjustment, i.e. compensation for friction lining wear. In parallel with this, in the B sector, i.e. in the area of the counter bearing 5, also inserted between the brake shoes 6a, 6b is a rod 9, which with further advantage may comprise a pretensioned spring accumulator. A counter bearing 5, e.g. supporting block, which is mounted essentially fixed to the anchor plate may in principle be designed as rigid or elastically yielding and, for example, also telescopic. For this purpose, the counter bearing 5 is placed arranged essentially between free ends of the two brake shoes 6a, 6b and diametrically opposite the two brake actuator systems 1a, 2.

The counter bearing 5 or supporting block and/or another system component also integrates at least one or more electrical sensing means, sensor(s) S, for the purpose of determining or measuring the braking torque when the brake drum is stationary and/or rotating. It is possible that the sensor system S is available for all modes; the sensor system may be specifically dedicated to just one function/mode, or it is alternatively or additionally possible for the sensor system to be provided redundantly for all modes. A sensor cable interface feed takes place with switching and feeding via the concentrated interface sectioning/interface concentration 11, 12 described further above.

The drum brake module comprises at least an additional elasticity integrated and/or separately provided elastic spring action, for example by means of a reversibly tensionable spring element which is implemented in the application force flow of the EPB actuating device, e.g. the MGU, or in one or more transmission means and/or braking elements. Placement and design of the spring element(s) in the application force flow of the EPB. For example can be integrated in rod 9,10 as disk spring layering with/without pretensioning force. In addition or separately, it is possible and purposive for the parking brake function to include/provide a further-developed spreading device with integrated elasticity, e.g. a spring-spreading lock. It is possible that elastic transmission means in the form of an elastic cable, elastic brake actuating lever 7 or in the form of a spring steel component are interposed between the EPB-MGU 1a and the brake holder 3 and brake shoes 6a, 6b. Due to its quasi-elastomeric adaptability, e.g. reversible breathing process, the proven elasticity allows a flexibilized and damage-free operating-mode or function transfer between the two actuating elements, that is service brake actuator 2 versus parking brake actuator 1a, in the context of complex loading or actuation, with the consequence that a particularly reversible compensation for a thermally induced shrinkage of the brake rotor 4 is also incidentally made possible.

The present embodiments are in no way restricted to automobiles, but instead its possible application extends in principle to all systems in which drum brake modules can essentially be usefully used.

As far as the mode arrangement, e.g. simplex/duo-servo, partly defined above in terms of design is concerned, in principle the most diverse, freely optional combinations or variations of the drum brake modes and types, such as simplex drum brakes, duo-servo drum brakes, duplex drum brakes, duo duplex drum brakes etc., are conceivable and can be provided interchangeably in any combination with one another without departing from the essence of the invention. In this context, the specification given of the simplex+duo servo combination presented here applies purely as an example and without excluding in any way the other optionally conceivable possible combinations or arrangements mentioned.

1-16. (canceled)

17. A combined drum wheel brake module comprising: a brake holder which can be fixed on a motor vehicle for conjoint rotation;
a counter bearing, with two brake shoes which are mounted opposite one another for conjoint rotation and which are arranged so as to be displaceable radially outward in the direction of a brake rotor designed as a brake drum;
at least one transmission device for actuating the brakes; and
two actuating devices, which are one of a hydraulic and electric service brake actuator and an electric parking brake actuator, wherein the service brake actuator and the electric parking brake actuator are fixed next to one another on the brake holder.

18. The combined drum wheel brake module as claimed in claim 17, wherein the brake holder has a circular disk-like geometry, and the service brake actuator and the electric parking brake actuator are arranged placed within first semi-circle on the brake holder.

19. The combined drum wheel brake module as claimed in claim 17, wherein the first semi-circle comprising the service brake actuator and electric parking brake actuator is arranged opposite a second semi-circle comprising the counter bearing.

20. The combined drum wheel brake module as claimed in claim 17, wherein the drum wheel brake has at least one integrated electrical sensor for measuring a service braking torque.

21. The combined drum wheel brake module as claimed in claim 17, wherein the drum wheel brake has at least one integrated sensor for measuring a parking braking force.

22. The combined drum wheel brake module as claimed in claim 17, wherein at least one electric parking brake actuator is respectively assigned an electrical current sensor in an electronic control unit.

23. The combined drum wheel brake module as claimed in claim 17, wherein the service brake actuator is a hydraulic piston-cylinder unit.

24. The combined drum wheel brake module as claimed in claim 17, wherein the service brake actuator is an electric actuator.

25. The combined drum wheel brake module as claimed in claim 17, wherein the service brake actuator is integrated as a simplex brake with brake shoes mounted for conjoint rotation on the counter bearing.

26. The combined drum wheel brake module as claimed in claim 17, wherein the electric parking brake actuator is integrated as a duo-servo brake, the applied parking clamping force flow of which is defined as substantially closed in the form of a ring with the aid of a rod inserted at one end between the brake shoes and with the aid of an adjusting rod inserted at the other end and directed substantially parallel to the rod and by way of the brake shoes spread by the transmission device and the brake rotor.

27. The combined drum wheel brake module as claimed in claim 17, wherein one of the counter bearing and another component incorporates an electrical sensor.

28. The combined drum wheel brake module as claimed in claim 17, wherein the brake shoes are elastically pretensioned toward one another by restoring springs elastically pretensioned in a defined manner, wherein the adjusting rod is clamped between the brake shoes in the first semi-circle for the purpose of automatic currentless compensation for friction lining wear, and in the second semi-circle, next to the counter bearing, a rod is inserted between the brake shoes.

29. The combined drum wheel brake module as claimed in claim 17, wherein the electric parking brake is equipped with an elasticity integrated in the application force flow.

30. The combined drum wheel brake module as claimed in claim 29, wherein the elasticity is an elastic element of defined spring stiffness.

31. The combined drum wheel brake module as claimed in claim 29, wherein the elasticity is present one of separately and implicitly.

32. The combined drum wheel brake module as claimed in claim 31 wherein the elasticity is provided by at least one of a counter bearing, a transmission device, a lever, a cable, a rod, an adjusting rod, and another brake component equipped with at least one elastic element.

33. The combined drum wheel brake module as claimed in claim 32 wherein the at least one elastic element is formed with at least one elastic spring element.

34. The combined drum wheel brake module as claimed in claim 32 wherein the elastic element is captively elastically pretensioned with a defined spring force.

35. The combined drum wheel brake module as claimed in claim 17, wherein a counter bearing is telescopic.
